(19) United States
(12) Patent Application Publication
(10) Pub. No.: US 2009/0155613 A1
(43) Pub. Date: Jun. 18, 2009

(54) Heat-Sensitive record material

(75) Inventor: Robert John Kalishek, Appleton, WI (US)

Correspondence Address: APPLETON PAPERS INC.;LAW DEPARTMENT, 825 E. WISCONSIN AVENUE, PO BOX 359, APPLETON, WI, 54912-0359, US

(73) Assignee: Appleton Papers Inc., Appleton, WI (US)

(21) Appl. No.: 12/292,578

(22) Filed: Nov. 21, 2008

Related U.S. Application Data
(60) Provisional application No. 61/007,880, filed on Dec. 17, 2007.

(51) Int. Cl. B32B 27/30

(52) U.S. Cl. 428/500

(57) ABSTRACT

The invention describes a heat sensitive recording material comprising a paper or film substrate having coated thereon a thermally sensitive color forming composition. The thermally sensitive color forming composition comprises a chromogenic dye precursor, and an acidic developer material. A high hydrolysis adhesive material is advantageously employed as a basecoat or in the color forming composition. The high hydrolysis adhesive material has a hydrolysis of at least 99% and yields a heat sensitive recording material of low background discoloration which is useful in wet offset UV cured printing.

This application under 35 USC §111(a) claims benefit per 35 USC §119(e)(1) to Ser. No. 61/007,880 filed Dec. 17, 2007.

### FIELD OF THE INVENTION

1. Background of the Invention

This invention relates to heat-sensitive or thermally-responsive record material. It more particularly relates to such record material in the form of sheets coated with color forming systems comprising chromogenic material, and acidic color developer. The invention particularly concerns a thermally-responsive record material having wet offset printability.

Flexographic printing can involve printing with radiation-curing inks. In UV flexographic or offset printing the inks or varnishes are polymerized by the action of UV radiation.

Offset is an indirect printing process. From the printing form, the ink is set off first to a rubber blanket and from there to the print material. The separation of the printing and nonprinting areas is based on the principle that fat and water repel each other. The printing areas of a metallic offset printing plate are prepared in such a way as to be hydrophobic (water repellent) and so they accept the fatty printing ink. The remaining areas remain hydrophilic (water-loving). For printing, both water and ink are supplied to the offset plate. The inking is done using an inking unit very similar to that of a letterpress machine. Wetting of the plate surface with water is carried out by means of a damping unit. Given a correct setting of the ink-water balance, separation between printing and nonprinting areas is sharp. This permits a printed image with dot precision and is particularly important in the case of halftone expanses or very fine features.

Direct thermally imaging recording materials are often used for applications such as lottery tickets, and often have imprints applied by means of flexographic or in particular by means of wet offset printing processes, particularly processes using UV cured inks.

It is therefore an object of the present invention to provide a heat-sensitive recording sheet which, as a ticket and here in particular as a lottery ticket has barcode readability, high environmental resistance, which, in the context of the invention, is to be understood as meaning the outstanding stability of the heat-sensitive recording sheet to water and to plasticizers, and is able to be printed in wet offset printing processes.

The invention envisages a further object of a recording sheet which, has printability in the flexographic and wet offset printing processes on its side provided with the heat-sensitive recording layer.

2. Description of Related Art

Thermally-responsive record material systems are well known in the art and are described in many patents, for example, U.S. Pat. Nos. 3,539,375; 3,674,535; 3,746,675; 4,151,748; 4,181,771; 4,246,318; and 4,470,057 which are incorporated herein by reference. In these systems, basic chromogenic material and acidic color developer material are contained in a coating on a substrate which, when heated to a suitable temperature, melts, sublimes or softens to permit said materials to react, thereby producing a colored mark.

Thermally-responsive record materials have characteristic thermal responses, desirably producing a detectable image of certain intensity upon thermal exposure which can be in a selective pattern to record into the record material various characters, images, patterns or other information.

A drawback with non topcoated thermally responsive record materials has been that non topcoated products, meaning papers and substrates with an active coat which does not carry a protective overcoat, have been poor in wet offset printability using UV cured inks. Piling occurs with nontopcoated thermally-responsive record materials. Piling is debris buildup on the printing blanket ultimately leading to defects in the image printed on the thermally-responsive record material.

### DETAILED DESCRIPTION

The present invention is an improved thermally-responsive record material having an intense image of high contrast on a white background. The thermally responsive record materials of the invention have a high degree of background whiteness, have high contrast and low background discoloration, are resistant to thermal printhead dusting, and are reduced in piling when used in offset printing processes such as wet offset UV printing.

Current non-topcoated thermal products have problems when they are wet offset printed using UV cured inks due to many printing issues, the main one being piling. UV cured inks are used with thermal products to reduce the amount of printhead residue that is built up during the thermal printing process. Piling during the ink printing process is caused by debris buildup on the printing blanket which causes defects in the printed image. This invention allows non-topcoated thermal papers to be wet offset printed using UV cured inks. Table 1 is a comparison of the UV wet offset printability of this invention versus other non-topcoated products.

To achieve a non-topcoated thermal recording material which is able to be wet offset printed particularly wet offset processes using UV cured inks is particularly challenging. UV cured inks have a level of tack which tends to lift or delaminate the active thermal layer from the paper substrate. This lifting or piling effect negatively affects the printing process and is undesirable. A non-topcoated thermally imaging recording material which is able to overcome such lifting yet provide a high degree of background whiteness while yielding intense imaging would be an advance in the art.

Surprisingly, applicants have found that these and other attributes can be imparted to thermal recording materials including papers and films by incorporating an extraordinary level of hydrolysis to the adhesive materials used as binder or with the binder in the base coat. In an alternative aspect the high hydrolysis material can be incorporated into the active coat, it being envisaged that in some constructs the base coat could be supplanted with the high hydrolysis material. The high hydrolysis material preferably has a hydrolysis of at least 99%.

In a preferred aspect, the heat sensitive recording material comprises a substrate having coated thereon a color-forming composition known as an active coat. This color-forming composition of chromogen, sensitizer and developer can be assembled as one or more layers. Often the active coat is a single layer.

The high hydrolysis material is selected to be a high strength water resistant adhesive or binder having a degree of hydrolysis of 99% or greater. Such adhesive or binder can be a vinyl ester. One such high hydrolysis adhesive material is poly(vinyl)alcohol.

Poly(vinyl alcohol) is typically produced by hydrolyzing poly(vinyl acetate). In hydrolysis, acetate groups are replaced with alcohol groups. The more acetate groups that are replaced, the greater the percent hydrolysis of the PVOH.

However, even after hydrolysis of the PVOH, it is known that a certain number of acetate groups remain attached to the PVOH molecule. For example, in a 95% hydrolyzed PVOH approximately 5% of the originally-present acetate groups remain attached to the molecule, whereas in a 99% hydrolyzed PVOH approximately 1% of the originally-present acetate groups remain attached to the molecule.

Commercial grades of polyvinyl alcohol are characterized on the basis of the degree of hydrolysis. Fully hydrolyzed polyvinyl alcohol is typically 98.0-98.8% hydrolyzed.

The grading scale often used is:

| | mole % hydrolysis |
|---|---|
| Super hydrolyzed | 99.3+ |
| Fully hydrolyzed | 98.0-98.8 |
| Intermediate hydrolyzed | 95.0-97.0 |
| Partially hydrolyzed | 87.0-89.0 |
| Low hydrolyzed | 79.0-81.0 |

Poly(vinyl alcohol) products such as Celvol 803 are sold by Celanese Corporation (Dallas, Tex.) as 87-89% hydrolyzed.

Celvol 165 and Celvol 125 are examples of polyvinylalcohols with % hydrolysis of 99% or greater and are known as super hydrolyzed.

Poly(vinyl alcohol) may be produced with various viscosities and various degrees of hydrolysis. Viscosity is typically a function of the molecular weight of the PVOH molecule. Specifically, a solution of PVOH in which the individual molecules are relatively large (i.e., a high molecular weight PVOH) tends to have a higher viscosity than a solution of PVOH in which the individual molecules are relatively small and of low molecular weight. It is believed that Van der Waals forces develop between the larger-sized molecules because such molecules tend to align themselves with one another, thus increasing the viscosity of the PVOH.

A poly(vinyl alcohol) such as Elvanol 71-30 (sold by Dupont (Wilmington, Del.) or Celvol 107 are typically referred to as a medium viscosity, fully hydrolyzed PVOH. Specifically, the degree of hydrolysis of a fully hydrolyzed PVOH is about 98%. Further, the viscosity of a medium viscosity grade PVOH such as Elvanol 71-30 is about 30 cps at 4% solution and 20° C.

Another commercially available PVOH is Elvanol 75-15 which is a low viscosity, fully hydrolyzed PVOH. The degree of hydrolysis is reported at 98% and viscosity of about 13 cps at 4% solution and 20° C.

The type of PVOH's used in the invention are those with a hydrolysis exceeding 99%. With a degree of hydrolysis of about 99.5%, Elvanol 90-50 is also considered a super hydrolyzed grade. The viscosity of a PVOH such as Elvanol 90-50 is about 13 cps at 4% solution and 20° C.

The high hydrolysis adhesive material used in the invention is preferably a super hydrolyzed polyvinyl alcohol however can include vinyl ester polymers such as polyacrylate or polymethacrylate. Such hydrolysable polymers include for purposes hereof copolymers of acrylic or methacrylic acid with one or more alkyl acrylates or methacrylates.

The high hydrolysis adhesive material imparts water resistance and improves adhesion particularly to hydrophilic surfaces. The high hydrolysis material can be used alone or preferably in coblends with conventional binders.

In one aspect, the basecoat useful in the invention comprises at least 15% of binder with at least 4% of a high hydrolysis adhesive material such as polyvinyl alcohol or a polyacrylic or polymethacrylic binder. In another aspect from 0-85% preferably 75% of the basecoat by weight comprises an oil absorptive pigment or plastic pigment particle or hollow sphere material. In another aspect from 0% to 4%, in yet another aspect 4% to 35%, and in a further aspect from 4% to 100% of the basecoat by weight can be comprised of the high hydrolysis adhesive material, and 0 to 96% or the balance of the basecoat can comprise conventional binder such as latex or conventional higher molecular weight polyvinyl alcohol.

Oil absorptive pigments are known and their use in thermal systems are taught to U.S. Pat. No. 5,124,306 Yamamoto et al., and U.S. Pat. No. 5,045,523 Funae et al. and are incorporated herein by reference. Hollow sphere insulating particles and plastic pigment insulating particles in thermal systems are taught in U.S. Pat. No. 4,904,635 Tamagawa et al; U.S. Pat. No. 4,929,590; Maruto et al., and U.S. Pat. No. 4,925,827 Goto et al., incorporated herein by reference.

Oil absorptive pigments, hollow sphere pigments, clays, calcined clays can be incorporated into the basecoat or optionally into the active coat. The oil absorptive pigments preferably have an oil absorption of at least 50 ml/100 g. The hollow sphere materials preferably have a void volume of at least 40%.

Super hydrolyzed polyvinyl alcohol (hydrolysis>99%) and/or polyacrylic binders are used in the construction of the thermal product to achieve the UV wet offset printability. When a basecoat is utilized the basecoat requires at least 15% binder with a minimum level of 4% of dry solids PVOH/or polyacrylic binder. A typical basecoat formula for this invention includes 75% by weight calcined clay; at least 4% super hydrolyzed PVOH binder; and 19% latex; with the remaining materials being a combination of surfactants, and viscosity modifiers. The thermal imaging layer preferably contains at least 12% super hydrolyzed PVOH and/or acrylic binder. A typical thermal imaging layer of this invention consists of 28% coreactant; 20% pigment; 15% super hydrolyzed PVOH binder; 13% dye; 12% pigment; and 10% sensitizer; with the remaining materials being a combination of slip aid, image stabilizers, surfactants, and viscosity modifier.

In the alternate embodiment of the heat sensitive recording material, the thermally sensitive color forming composition can optionally include in addition bis(3-allyl-4-hydroxyphenyl)sulfone. In one aspect bis(3-allyl-4-hydroxyphenyl)sulfone is at 0.1 to 80 weight percent and in another aspect from 5 weight percent to 75 weight percent, and preferably about 5 to 25 weight percent, based on weight of the thermally sensitive color forming composition.

Optionally, the thermally sensitive color forming composition can include in addition a sensitizer.

The sensitizer is preferably selected from materials such as 1,2-diphenoxyethane, acetoacet-o-toluidine, dimethyl terephthalate, p-benzylbiphenyl, bis-(3-allyl-4-hydroxyphenyl)sulfone, 4,4-dihydroxydiphenylsulfone, phenyl-1-hydroxy-2-naphthoate, fatty acid amide such as stearamide, alone or in combination.

Thermally-responsive or heat-sensitive recording materials bear a thermally-sensitive color forming composition comprising a chromogenic material and an acidic developer material in substantially contiguous relationship, whereby the melting, softening or sublimation of either material produces a color, in other words a change-in-color reaction.

A sensitizer (also known as a modifier) such as a 1,2-diphenoxyethane is preferably included. Such material typically does not impart any image on its own and is not considered active in the formation of color but as a relatively low melting solid acts as a solvent to facilitate reaction between the mark-forming components. Other such sensitizers are described in U.S. Pat. No. 4,531,140. Other sensitizers for example can include N-acetoacetyl-o-toluidine, phenyl-1-hydroxy-2-naphthoate, dibenzyloxalate, bis-(3-allyl-4-hydroxyphenyl)sulfone and para-benzylbiphenyl by way of illustration and without limitation.

The color forming composition (or system) of the record material of this invention comprises chromogenic material in its substantially colorless state and acidic developer material dispersed in a binder material. The color forming system typically relies upon melting, softening, or subliming one or more of the components to achieve reactive, color producing contact.

The record material includes a substrate or support material which is generally in sheet form. For purposes of this invention, sheets can be referred to as substrates or support members and are understood to also mean webs, ribbons, tapes, belts, films, labels, cards and the like. Sheets denote articles having two large surface dimensions and a comparatively small thickness dimension. The substrate or support material can be opaque, transparent or translucent and could, itself, be colored or not. The material can be fibrous including, for example, paper and filamentous synthetic materials. It can be a film including, for example, cellophane and synthetic polymeric sheets cast, extruded, or otherwise formed. Invention resides in the color forming composition coated on the substrate. The kind or type of substrate material is not critical.

The components of the color forming system are in a proximate relationship meaning, a substantially contiguous or near contiguous relationship, substantially homogeneously distributed throughout the coated layer material deposited on the substrate in one or more layers. In manufacturing the record material, a coating composition is prepared which includes a fine dispersion of the components of the color forming system, binder material typically a polymeric material, surface active agents and other additives in an aqueous coating medium. As will be readily evident to the skilled artisan, the reactive components can be dispersed and coated in the same layer or in separate layers. For example the chromogenic materials can be in one layer and the developer materials optionally in the same layer or in separate layers above or below the layer with chromogenic material. A protective overcoat layer such as polyvinylalcohol or its derivatives or other binder materials while optionally can be utilized, however is not required and not preferred. Optionally any of the layer or layers can be spot printed for specialized applications. Most commonly, the entire sheet is coated. Application of the color forming composition to both sides of the substrate, flood coating both sides or partially coating one or both sides while flood coating any remainder are also options. The composition can additionally contain inert pigments, such as clay, talc, aluminum hydroxide, calcined kaolin clay and calcium carbonate; synthetic pigments, such as urea-formaldehyde resin pigments; natural waxes such as Carnauba wax; synthetic waxes; lubricants such as zinc stearate; wetting agents; defoamers, and antioxidants.

The color forming system components are substantially insoluble in the dispersing vehicle (preferably water) and are ground to an individual average particle size of from less than 1 micron to less than about 10 microns, preferably less than about 3 microns. A binder can be included. The binder can be a polymeric material and is substantially vehicle soluble although latexes are also eligible in some instances. Preferred water soluble binders include polyvinyl alcohol, hydroxy ethylcellulose, methylcellulose, methyl-hydroxypropylcellulose, starch, styrene maleic anhydride salts, modified starches, gelatin and the like. Eligible latex materials include polyacrylates, styrene-butadiene-rubber latexes, polyvinylacetates, polystyrene, and the like. The polymeric binder is used to protect the coated materials from brushing and handling forces occasioned by storage and use of thermal sheet. Binder should be present in an amount to afford such protection and in an amount less than will interfere with achieving reactive contact between color forming reactive materials. Polymeric binders such as polyvinyl alcohol, polyvinyl acetate, and polyacrylate can be optionally employed as a protective layer for special applications coated over the thermally imaging layer or layers, but is not required nor preferred.

In one aspect of the invention the high hydrolysis adhesive material has a hydrolysis of at least 99%, preferably 99.3%, more preferably of at least 99.5%. The high hydrolysis adhesive material can be blended into one or more layers of the thermally sensitive color forming composition or preferably into the basecoat. The basecoat is typically a binder material selected from various water soluble binders and latexes. In a preferred embodiment, the high hydrolysis adhesive material is blended at about 4% by weight of the basecoat of polyacrylate latex, styrene-butadiene-rubber latex, polyvinylacetate latex or polystyrene latex.

Coating weights can effectively be about 1 to 12 grams per square meter (gsm), more preferably from 3 to about 9 grams per square meter (gsm) and usefully about 5 to about 6 gsm. The practical amount of coating or color forming materials is controlled by economic considerations, functional parameters and desired handling characteristics of the coated sheets.

The chromogens could include any of the conventional chromogens such as the phthalide, leucoauramine and fluoran compounds. Other examples of chromogen compounds include Crystal Violet Lactone (3,3-bis(4-dimethylaminophenyl)-6-dimethylaminophthalide, U.S. Pat. No. Re. 23,024); phenyl-, indolyl, pyrrolyl, and carbazolyl substituted phthalides (for example, in U.S. Pat. Nos. 3,491,111; 3,491,112; 3,491,116; 3,509,174); nitro-, amino-, amido-, sulfonamido-, aminobenzylidene-, halo-, anilino-substituted fluorans (for example, in U.S. Pat. Nos. 3,624,107; 3,627,787; 3,641,011; 3,642,828; 3,681,390); spirodipyrans (U.S. Pat. No. 3,971,808); and pyridine and pyrazine compounds (for example, in U.S. Pat. Nos. 3,775,424 and 3,853,869).

Other eligible chromogenic compounds include 3-diethylamino-6-methyl-7-anilino-fluoran (U.S. Pat. No. 3,681,390); 2-anilino-3-methyl-6-dibutylamino-fluoran (U.S. Pat. No. 4,510,513) also known as 3-di-n-butylamino-6-methyl-7-anilino-fluoran; 3-di-n-butylamino-7-(2-chloroanilino)fluoran; 3-(N-ethyl-N-tetrahydrofurfurylamino)-6-methyl-7-3,5′6-tris(dimethylamino)spiro[9H-fluorene-9,1′(3′H)-isobenzofuran]3′-one; 7-(1-ethyl-2-methylindole-3-yl)-7-(4-diethyl-amino-2-ethoxyphenyl)-5,7-dihydrofuro[3,4-b]pyridin-5-one (U.S. Pat. No 4,246,318); 3-diethylamino-7-(2-chloroanilino)fluoran (U.S. Pat. No. 3,920,510); 3-(N-methylcyclohexylamino)-6-methyl-7-anilinofluoran (U.S. Pat. No. 3,959,571); 7-(1-octyl-2-methylindole-3-yl)-7-(4-diethyl-amino-2-ethoxyphenyl)-5,7-dihydrofuro[3,4-b]pyridin-5-one; 3-diethylamino-7,8-benzofluoran; 3,3-bis(1-ethyl-2-methylindole-3-yl)phthalide; 3-diethylamino-7-anilinofluoran; 3-diethylamino-7-benzylaminofluoran; 3′-phenyl-7-dibenzylamino-2,2′-spirodi-[2H-1-benzopyran] and mixtures of any of the above.

Examples of eligible acidic (or electron accepting) color developer material include the compounds listed in U.S. Pat. No. 3,539,375 as phenolic reactive material, particularly the monophenols and diphenols. Eligible acidic developer material also includes, without being considered as limiting, the following compounds which may be used individually or in mixtures: 4,4′-isopropylidine-diphenol (Bisphenol A); p-hydroxybenzaldehyde; p-hydroxybenzophenone; p-hydroxypropiophenone; 2,4-dihydroxybenzophenone; 1,1-bis(4-hydroxyphenyl)cyclohexane; salicylanilide; 4-hydroxy-2-methylacetophenone; 2-acetylbenzoic acid; m-hydroxyacetanilide; p-hydroxyacetanilide; 2,4-dihydroxyacetophenone; 4-hydroxy-4′-methylbenzophenone; 4,4′-dihydroxybenzophenone; bis(3-allyl-4-hydroxyphenyl)sulfone, 2,2-bis(4-hydroxyphenyl)-4-methylpentane; benzyl-4-hydroxyphenyl ketone; 2,2-bis(4-hydroxyphenyl)-5-methylhexane; ethyl-4,4-bis(4-hydroxyphenyl)-pentanoate; isopropyl-4,4-bis(4-hydroxyphenyl)pentanoate; methyl-4,4-bis(4-hydroxyphenyl)pentanoate; allyl-4,4-bis(4-hydroxyphenyl)pentanoate; 3,3-bis(4-hydroxyphenyl)-pentane; 4,4-bis(4-hydroxyphenyl)heptane; 2,2-bis(4-hydroxyphenyl)-1-phenylpropane; 2,2-bis(4-hydroxyphenyl)butane; 2,2′-methylene-bis(4-ethyl-6-tertiarybutylphenol); 4-hydroxycoumarin; 7-hydroxy-4-methylcoumarin; 2,2′-methylene-bis(4-octylphenol); 4,4′-sulfonyldiphenol; 4,4′-thiobis(6-tertiarybutyl-m-cresol); methyl-p-hydroxybenzoate; n-propyl-p-hydroxybenzoate; benzyl-p-hydroxybenzoate; 4-( 4-(1-methylethoxy)phenyl)sulphonyl phenol. Preferred among these are the phenolic developer compounds. More preferred among the phenol compounds are 4,4′-isopropylidinediphenol, ethyl-4,4-bis(4-hydroxyphenyl)pentanoate, n-propyl-4,4-bis(4-hydroxyphenyl)pentanoate, isopropyl-4,4-bis(4-hydroxyphenyl)pentanoate, methyl-4,4-bis(4-hydroxyphenyl)pentanoate, 2,2-bis(4-hydroxyphenyl)-4-methylpentane, p-hydroxybenzophenone, 2,4-dihydroxybenzophenone, 1,1-bis(4-hydroxyphenyl)cyclohexane, and benzyl-p-hydroxybenzoate; 4-(4-(1-methylethoxy)phenyl)sulphonyl phenol and 4,4′-[1,3-phenylenebis(1-methylethylene)]bisphenol. Acidic compounds of other kind and types are eligible. Examples of such other acidic developer compounds are phenolic novolak resins which are the product of reaction between, for example, formaldehyde and a phenol such as an alkylphenol, e.g., p-octylphenol, or other phenols such as p-phenylphenol, and the like; and acid mineral materials including colloidal silica, kaolin, bentonite, attapulgite, hallosyte, and the like. Some of the polymers and minerals do not melt but undergo color reaction on fusion of the chromogen. Of the foregoing particularly the phenol type of compounds are more preferable acidic developer materials.

The following examples are given to illustrate some of the features of the present invention and should not be considered as limiting. In these examples all parts or proportions are by weight and all measurements are in the metric system, unless otherwise stated.

In the examples illustrating the present invention a dispersion of a particular system component was prepared typically by milling the component in an aqueous solution of a binder until a particle size of less than about 1 micron to less than about 10 microns was achieved. The desired average particle size was less than 3 microns in each dispersion.

In table 1, the percents by weight are relative to the active coat for the materials other than the basecoat. Balance of materials are typically clays, fillers, rheology modifiers, antioxidants, lubricants and waxes. Balance of materials in basecoat are typically clays, insulators, hollow spheres and polyvinyl alcohol latexes.

In practice the coatings or one or more coating layers can be applied to a substrate by any known coating technique including rod coating, blade coating, slot die, curtain or curtains, air knife, casting drum, gravure, reverse roll coating, bead coating, extrusion, spraying, spot printing, blade coating, and other coating methods known in the art.

The thermally-responsive sheets were made by making separate dispersions of chromogenic material and acidic material. The dispersions were mixed in the desired ratios and applied to a support with a wire wound rod and dried. Other non-active (as that term is understood in this application) materials such as modifiers, fillers, antioxidants, lubricants and waxes can be added if desired. The sheets may be calendered to improve smoothness. The dispersions were prepared in a small media mill.

### EXAMPLES

| | | Comparative | | Comparative | |
|---|---|---|---|---|---|
| | Example 1 | Example 1 | Comparative Example 2 | Example 3 | Comparative Example 4 |
| Chromogen | 3-dibutylamino-6- | 2-anilino-6′- | 3-dibutylamino-6- | 3-dibutylamino-6- | 3-dibutylamino-6-methyl- |
| | methyl-7-anilino-fluoran | diethylamino-3′- | methyl-7-anilino fluoran | methyl-7- | 7-anilino fluoran |
| | 15% by wt | methyl fluoran | 15% by wt | anilinofluoran | 15% by wt |
| | | and 3- | | 15% by wt | |
| | | dibutylamino-6- | | | |
| | | methyl-7-anilino- | | | |
| | | fluoran | | | |
| | | 15% by wt | | | |
| Developer | 4-4- | 2,2-bis (4- | Bis-(3-allyl-4- | 4,4- | 4,4- |
| | dihydroxydiphenylsulfone | hydroxyphenyl)- | hydroxyphenyl)sulfone | dihydroxydiphenylsulfone | dihydroxydiphenylsulfone |
| | 30% by wt | 4-methylpentane | 30% by wt | 30% by wt | 30% by wt |
| | | 20% by wt. | | | |
| Sensitizer | Wax + 1,2 | 1,2- | 1,2-diphenoxyethane | Wax + 1,2- | wax |
| | diphenoxyethane | diphenoxyethane | 5% by weight | diphenoxyethane | 14% by wt |
| | 7% by wt | 20% by wt | | 7% by wt | |
| Binder | PVOH hydrolysis 99.3% | PVOH hydrolysis | PVOH hydrolysis 98% | PVOH hydrolysis | PVOH hydrolysis 99.3 |
| | 15% by wt | 98% | 19% by wt | 99.3 | 14% by wt |
| | | | | 15% by wt | |
| Basecoat | Latex (15% by wt) + | styrene butadiene | Styrene butadiene | Styrene butadiene | Styrene butadiene rubber |
| | PVOH hydrolysis 99.3 | rubber latex | rubber latex | rubber latex | latex |
| | 4% by wt | 18% by wt | 18% by wt | 15% by wt | 15% by wt |

Parts by weight

| Dispersion A - Chromogenic Material | |
|---|---|
| Chromogenic Material | 32 |
| Binder, 20% solution PVOH in water | 27 |
| Defoaming and dispersing agents | 0.5 |
| Water | 40.5 |
| Dispersion A1 - Chromogenic Material is ODB-2 | |
| 3-dibutylamino-6-methyl-7-anilino fluoran | |
| Dispersion B - Acidic Material | |
| Acidic Material | 40 |
| Binder, 20% solution PVOH in water | 22 |
| Defoaming and dispersing agents | 0.5 |
| Water | 37.5 |
| Dispersion B1 - Acidic Material is TGSA | |
| Bis(Hydroxyphenyl)sulfone | |
| Dispersion B2 - Acidic Material is bis-(3-allyl-4-hydroxyphenyl)sulfone | |
| Dispersion C - Sensitizing Material | |
| Sensitizing Material | 38 |
| Binder, 20% solution PVOH in water | 30 |
| Defoaming and dispersing agents | 0.5 |
| Water | 31.5 |
| Dispersion C1 - Sensitizing Material DPE | |
| 1,2-Diphenoxyethane | |
| Dispersion C2 - Sensitizing Material is bis-(3-allyl-4-hydroxyphenyl)sulfone | |
| Dispersion C3 - Sensitizing Material is stearamide | |
| Dispersion D- Additive Material | |
| Defoaming and dispersing agents | 0.5 |
| Water | 40.5 |
| Dispersion D1 - 99.3% hydrolyzed PVOH | |
| Dispersion D2 - Additive Material is 99.5% hydrolyzed PVOH | |
| | Parts |
| Active Coating Formulation 1 | |
| Dispersion A (Chromogenic Material) | 22 |
| Dispersion B (Acidic Material) | 37 |
| Dispersion C (Sensitizing Material) | 23 |
| Binder, 10% solution of PVOH in water | 5 |
| Latex | 6 |
| Water | 7 |
| Base Coat 1 | |
| Dispersion D | 4 |
| Polyacrylate binder | 15 |
| Calcined clay | 75% |
| Base Coat 2 | |
| Dispersion D | 4 |
| Styrene butadiene latex | 15 |
| Hollow sphere Ropaque (Rohm & Haas) | 75% |

```
Control
    Active Coating Formulation 1 using
        Dispersion A
        Dispersion B1
        Dispersion C1 (DPE)
    Basecoat
        Styrene butadiene latex
Example 2
    Active Coating Formulation 1 using
        Dispersion A1
        Dispersion B1
        Dispersion C1 (DPE)
        Dispersion D1
    Basecoat
        Basecoat 1 or 2 using Dispersion D1
Example 3
    Active Coating Formulation 1 using
        Dispersion A1 (ETAC)
        Dispersion B1 (TGSA)
        Dispersion C1 (DPE)
        Dispersion D2
    Basecoat
        Basecoat 1 or 2 using Dispersion D2
Example 4
    Active Coating Formulation 1
        Dispersion A
        Dispersion C3
        Basecoat 1 using Dispersion D1 or D2
```

TABLE 2
UV ink wet offset printability comparison

| | # of prints | piling rate (0-10, good-bad) |
|---|---|---|
| Example 1 | 75,000 | 2 |
| Comparative Example 1 | 20,000 | 4 |
| Comparative Example 2 | 10,000 | 6 |
| Comparative Example 3 | 10,000 | 8 |
| A (Commercial product) | 2,000 | 9 |
| B (Commercial product) | 2,000 | 8 |
| Comparative Example 4 | 1,000 | 10 |
| C (Commercial product) | 200 | 10 |

Binder limits for basecoat: min = 15% dry solids; max = 30% of dry solids
PVOH/Acrylic limits for basecoat: min = 4% of solids; max = 30% of dry solids
Binder limits for active coat: min = 12% of solids max = 25% of solids
PVOH/Acrylic limits for basecoat: min = 12% of solids; max = 25% of dry solids

TABLE 3

| | | | | | Number of Impressions & Piling Rating | | | | |
|---|---|---|---|---|---|---|---|---|---|
| Basecoat | | | | | Activecoat | | | | |
| | % Total | | % Celvol | % Celvol | 10% Celvol | | 20% Celvol | 10% Celvol | 15% Celvol |
| Example | Binder | % Latex | 125 | 325 | 125 | 15% Celvol 125 | 125 | 325 | 325 |
| 5 | 24 | 24 | 0 | 0 | 500-10-5 | 21,500-10-10 | 14,000-1-0 | | |
| 6 | 24 | 20 | 4 | 0 | 200-10-10 | 31,400-8-4 | 34,600-1-1 | | |
| 7 | 24 | 16 | 8 | 0 | 13,200-5-10 | 34,600-4-0 | 33,400-2-0 | 16,000-3-6 | 15,300-2-0 |
| 8 | 18 | 14 | 4 | 0 | 8,000-10-10 | 15,400-10-8 | | | |
| 9 | 16 | 8 | 8 | 0 | 33,500-6-1 | 39,000-4-4 | | | |
| 10 | 14 | 4 | 10 | 0 | 7,000-10-10 | 16,000-6-10 | | | |
| 11 | 12 | 0 | 12 | 0 | 3,500-7-10 | 11,800-5-10 | | | |
| 12 | 12 | 12 | 0 | 0 | 2,500-10-10 | | 18,000-8-3 | | |
| 13 | 24 | 16 | 0 | 8 | 13,250-7-7 | 14,300-2-4 | | 10,600-6-5 | 13,800-1-1 |
| 14 | 14 | 4 | 0 | 10 | | 12,700-6-10 | | | 16,000-4-8 |

NUMBER OF IMPRESSIONS - TOWER 2 PILING RATING - TOWER 3 PILING RATING
Piling rating: 0 = no piling; 10 = excessive piling that can destroy printing blanket
Celvol 125 is super hydrolyzed
Celvol 325 is fully hydrolyzed

In Table 3 Celvol 125 is used in the active coat at loading levels of 10%, 15% and 20% by weight. Celvol 125 (Celanese Corporation, Dallas, Tex.) is a super hydrolyzed polyvinyl alcohol.

In Examples 6 to 11 the basecoat is a super hydrolyzed polyvinyl alcohol. In Example 7, with the basecoat and active coat including superhydrolyzed polyvinylalcohol, almost twice as many printing impressions are achievable with equal or better piling rates related to increasing concentrations of superhydrolyzed polyvinyl alcohol binder adhesive. At an active coat layer concentration of 20% Celvol 125, 33,400 impressions were achievable and a piling rate of 2-0 in towers 2 and 3 respectively. With a polyvinyl alcohol hydrolyzed at less than 99%, only 15,300 printing impressions were obtainable.

The principles, preferred embodiments, and modes of operation of the present invention have been described in the foregoing specification. The invention which is intended to be protected herein, however, is not to be construed as limited to the particular forms disclosed, since these are to be regarded as illustrative rather than restrictive. Variations and changes can be made by those skilled in the art without departing from the spirit and scope of the invention.

All patents and publications cited herein are hereby fully incorporated by reference to the extent such disclosure is not inconsistent with this invention and for all jurisdictions in which such incorporation is permitted. The citation of any publication is for its disclosure prior to the filing date and should not be construed as an admission that such publication is prior art or that the present invention is not entitled to antedate such publication by virtue of prior invention.

What is claimed is:

1. A non-topcoated heat-sensitive recording material comprising a substrate having coated thereon a thermally sensitive color forming composition in one or more layers, the thermally sensitive color forming composition comprising a chromogenic dye precursor, and an acidic developer material, and a binder material, the binder material comprising a high hydrolysis adhesive material having a hydrolysis degree of at least 99%.

2. The heat sensitive recording material according to claim 1 wherein the binder material comprises a basecoat positioned between the thermally sensitive color forming composition and the substrate.

3. The heat sensitive recording material according to claim 2 wherein-the basecoat comprises a blend of a high hydrolysis adhesive and a latex.

4. The heat sensitive recording material according to claim 1 wherein the high hydrolysis adhesive material is a hydrolyzed polyvinyl alcohol.

5. The heat sensitive recording material according to claim 1 wherein the high hydrolysis adhesive material has a hydrolysis of at least 99.3%.

6. The heat sensitive recording material according to claim 4 wherein the high hydrolysis adhesive material has a hydrolysis of at least 99.5%.

7. The heat sensitive recording material according to claim 1 wherein the high hydrolysis adhesive material is blended into one or more layers of the thermally sensitive color forming composition.

8. The heat sensitive recording material according to claim 1 wherein the high hydrolysis adhesive material comprises a basecoat under the thermally sensitive color forming composition.

9. The heat sensitive recording material according to claim 1 wherein one or both of the color forming composition and basecoat comprises in addition an oil absorptive pigment having an oil absorption of at least 50 ml/100 g.

10. The heat sensitive recording material according to claim 1 wherein one or both of the color forming composition and basecoat comprises in addition an insulating hollow sphere material or porous plastic pigment.

11. A non-topcoated heat-sensitive recording material comprising a substrate having coated thereon a thermally-sensitive color forming composition in one or more layers, the thermally sensitive color forming composition comprising a chromogenic dye precursor, an acidic developer material and a binder material, and at least 4% by weight of the binder material comprising a hydrolyzable vinyl ester having a hydrolysis of degree of 99% or greater.

12. The heat sensitive recording material according to claim 11 wherein the binder material is a hydrolysable vinyl ester and comprises in addition a basecoat under the thermally sensitive color forming composition, the basecoat comprising a hydrolysable vinyl ester having a degree of hydrolysis of 99% or greater.

13. The heat sensitive recording material according to claim 11 wherein the binder material is a hydrolyzed polyvinyl alcohol.

14. The heat sensitive recording material according to claim 11 wherein the binder material has a hydrolysis of at least 99.3%.

15. The heat sensitive recording material according to claim 13 wherein the binder material has a hydrolysis of at least 99.5%.

16. The heat sensitive recording material according to claim 11 wherein the binder material is blended into one or more layers of the thermally sensitive color forming composition.

17. The heat sensitive recording material according to claim 12 wherein one or both of the color forming composition and basecoat comprises in addition an oil absorptive pigment.

18. The heat sensitive recording material according to claim 12 wherein one or both of the color forming composition and basecoat comprises in addition an insulating hollow sphere material with a void volume of at least 40%.

19. The heat sensitive recording material according to claim 12 wherein the basecoat comprises as oil absorptive pigment or insulating hollow sphere material.

20. The heat sensitive recording material according to claim 12 wherein the basecoat comprises in addition a latex material.

21. The heat sensitive recording material according to claim 11 wherein the heat sensitive composition comprises in addition a basecoat positioned between the thermally sensitive color forming composition and the substrate.
